(19) United States
(12) Patent Application Publication
(10) Pub. No.: US 2007/0140214 A1
(43) Pub. Date: Jun. 21, 2007

(54) Method for accessing a packet-switched network financed by a provider for electronic trade and payment and for running a telecommunication system based on a partnership bonus principle

(76) Inventor: Pal Zoltan, Budapest (HU)

Correspondence Address: Zoltan Pal, Uhlandstr 27, Marbach am Neckar, D-71672, DE

(21) Appl. No.: 10/566,939

(22) PCT Filed: Jul. 23, 2004
(86) PCT No.: PCT/HU04/00079

§ 371 Date: Mar. 12, 2007

(30) Foreign Application Priority Data
Jul. 24, 2003 (DE) 103 33 831.4
Sep. 12, 2003 (DE) 103 42 527.6
Sep. 18, 2003 (DE) 103 43 701.0
Oct. 19, 2003 (DE) 103 49 355.7
Dec. 11, 2003 (DE) 103 58 797.7
Jan. 29, 2004 (DE) 10 2004 004 639.5

(51) Int. Cl. H04L 12/66

(52) U.S. Cl. 370/352; 370/401

(57) ABSTRACT

The process for bidder-financed packet-switched telecommunication partner system for electronic commerce and account of premiums for partners is a special service of an Internet Service Provider, where the said service enables the customers to access free of charge all the offered services of the sellers and bidders of services by means of telecommunication and additionally the turnover made by electronic commerce is rewarded automatically with telecommunication services as electronic premium.

The invention relates to a method for telecommunication, e-trade, motivation and giving premium respectively the buyers within new intelligent packet-switched networks using networks and processes such as Internet, XDSL, GPRS, UMTS, WAP and all packet-switched applications and devices based on the Internet like Access Points, modems, routers, switches etc. The method is a new process for electronic telecommunication services, sales and awarding, which can be accomplished by Internet in the best way.

The invention has the following essential characteristics, that the buyer, customer or client can communicate cost free with the vendor or salesman either through Internet or mobile phone paid by the bidders, suppliers, providers, contractors or partners thereof, he or she (i.e. the buyer, customer or client) can use the most up-to-date wireless technologies, which make the shopping easy from a place in the shops or premises, where the dwelling place and the web-site are connected and supported by Internet, and the shopping can be accomplished using the so-called Store Engine or electronic selling apparatuses, and the buyer is awarded for his or her turnover and adherence with telecommunication services through wired or wireless networks.

Consequently the buyer does not buy telecommunication services any more either directly from his or her mobile phone or through an arbitrary Telco or an Internet services provider what he or she (i.e. the buyer, customer or client) had to pay up to now, but he or she orders, buys and pays for a ware or service through e-trade web pages maintained by the vendors or servicing companies and receives an award after each transaction by telecommunication in form of services or any other form, which may be transmitted through the network or recorded to credit or loaded into his or her (i.e. the buyer's, customer's or client's) account of premiums.

It is more than 130 years that the wired telephone and central exchange were invented. There were no solutions financed by the bidders, suppliers, providers, contractors or partners thereof, offered in the first time. Later the so-called R-talks or 0800 ones and other solutions were invented and introduced, where the costs were held by the called partner i. e. they were financed by the bidder. The now existing packet-switched telecommunication processes make exactly the same with a great difference that the centers of connecting and accounting were abolished or no more used, because the information, documents, conversation etc. are cut in small parts in these new intelligent networks and each part is addressed according to Internet protocol sent to the destination and assembled there. All the active registered participants are always connected one with all others in the Internet, the packets are always addressed with static or dynamic IP addresses to the participants and these addresses are usually translated through DNS (Domain Name Systems) into domain names. In addition a NAT i. e. Network Address Translator can also included resolving the harmonization of local and Internet IP addresses and translates them if necessary, but from the viewpoint of the invention these functions of the Internet are not too interesting.

It seemed that no communication and accounting centers can be used in the intelligent networks, because each IHSP or IASP (Internet Hosting Service Provider or Internet Access Service Provider) registered and accounted the data turnover generated by them, as well as by Internet for their user. There are always two providers participating in an Internet connection, the first one, who provides, stores, hosts respectively delivers data and a second one, who enables the access to, as well as to down-load these data stored in host computers and sells the services to its customers. These intelligent packet-switched networks had although a great disadvantage, that they could not offer the customers any telecommunication solution paid by the bidder, wherein the attended HINDUS (Host, IP address, Network, Domain names, URL, Servers) could take on itself the costs of Internet access.

The solutions and telecommunication processes financed by the bidder, supplier, provider, contractor or partner thereof have although great importance on the ground of marketing technique and they became in some cases even essential, as each seller or service company can recognize that the 0800 telephone numbers financed by the bidder are much better accepted by the customers than those paid by the customers themselves. The most important moment of all the commercial affairs is that the customers contact with the sellers or service companies, first they can get to know the variety of goods or services. It is highly important for this reason to make this first step easier to the customers or visitors by taking over also the telecommunication costs, which are reduced to small parts.

The invention gives the customers the same possibilities in the virtual world, that were usual formerly in the real world, i. e. the customer (i.e. any kind of buyer, customer or client) can look cost-free at the electronic shop-windows respectively enter virtually the shops of any seller, or servicing company on the costs of the bidders and all the participating Internet domains or Internet shops may be attended and on the costs of the bidder, and the shopping can be made thereafter. The systems FOSS (Free Online Shopping System) or OSS (Open Shop System) have become extraordinarily interesting for sellers and service companies, i. e. all the bidders of goods or services (i.e. any kind of bidders, suppliers, providers, contractors or partners thereof), because they reduced the communication costs with the spreading of packet-switched telecommunication processes to a small part of those of wired telecommunication and, as the bidders took over the telecommunication costs, they could realize higher number of attending customers and more turnover and profit in this way.

As all types of telecommunication on the base of Internet protocol charge always two accounts, all participants have paid themselves their own uploads and downloads either as hosting fee or as access fee. This problem is solved by the invention by various technical ways, where User Dependent Internet Access Accounts and HINDUS BAS (Host, Home site or Homepage, IP-address [Internet Protocol Address], Network, Domain URL [Uniform Resource Locator] and/or simply BAS [Based Access Accounting]) dependent access accounts are opened, which enable a limited access only for the participating hosts, home sites or homepages, IP-addresses (Internet Protocol Addresses), networks, domain URL-s (Uniform Resource Locators) and hinder the surfing or click out from the said websites using some technical measures, however a click out of these sites should not hinder by technical measures at all, as when a customer clicks to another domain, the cost bearer will be changed. When the customer clicks e. g. from a page financed by a bidder to another one not financed by a bidder, his or her account will be charged in the known way that can be paid either by payment or from his or her premium account.

Those measures can have various forms from the compulsive routing to the blocking of browsing when the interest of customers reduces, where the measures are important necessarily only for the centers of transmission and of account, as the account centers can register each arbitrary click and they may be financed either publicly and/or privately depending on the user, and/or the enabled access is paid in units by the transmitting telecommunication port or unit accounted and/or after each transaction of buying and sale is paid from the account of premiums depending on the user. It is important in this process may be attended only those Internet pages, domains, IP addresses URL-s, or Server Hosts, the operators or owners of SISP (Special Internet Service Provider) have declared previously that they take over the costs of Internet access of their websites.

When the users can login for their own costs through the desired host to those websites, and the data turnover can not be uploaded or downloaded from them but only through RASPPPoE (Remote Access Services Point to Pont Protocol over Ethernet), the users or the customers can log in direct at the server, host or network by his or hers HINDUS BAS (Host, IP-Addresses, Network, Domain, URL, Server Based Accounting Services) and enable to account his or her visits, where the desired contents can be directly taken, the costs related to the hosting in the Internet, und the fees for Internet access arise and appear only once and they are charged on the account of the owner of the website or the domain.

Let us name this process XCF-PBHS (Extremely Customer friendly-Professional Business Hosting Services) or DIPUS (Direct Internet Pick Up Services) or VIPS (Very Important Purchaser Services) process wherein the owner of the host or domain pays also the fees of log in the Internet instead of its visitor, but it does so always only according for its own interest. That who pays can always define for which domains and which visitors will pay the costs for Internet access.

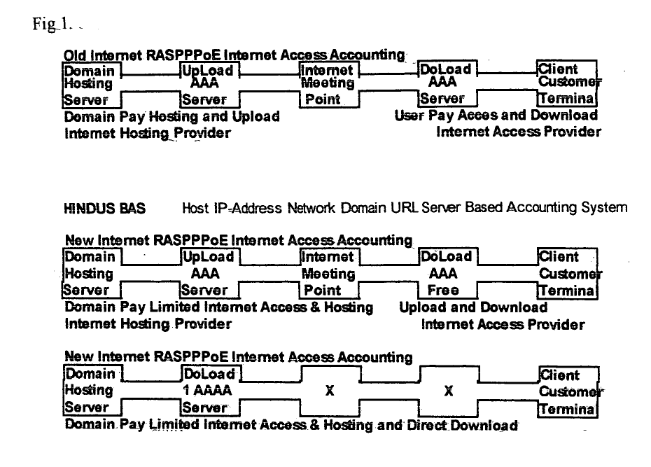

As it is not necessary that two ISP participate as Host and as Access Provider in the new process financed by the bidder (one for upload for the 1^{st} ISP and another for download for the 2^{nd} ISP), the costs do not arise for the visitor or customer, who logs in through his or her HINDUS BAS (Host, IP-Addresses, Network, Domain, URL, Server Based Accounting Services) at a sole SISP (Special Internet Services Provider), which sales the hosting and internet access for its customers in a packet and delivers the desired contents, information and pages cost-free and anybody logging in to it can take these contents free in a way financed by the bidder, which is shown in the FIG. 1.

The FIG. 1 is explained here.

The First Uppermost Line of the Diagram is the old Internet RASPPPoE (Remote Access Services Point to Point Protocol over Internet) Internet Access Accounting, which shows, how a data transfer is accomplished currently in the Internet.

The participants on the left are integrated with or connected to the Hosting ISP with the Hosting Server or with the AAA—Authentication, Authorization and Accounting Server, which collects the fees for presentation in the Internet or the fees for delivery through Internet or the fees for storing data in the Internet, fees for the uploaded data for HINDUS host, IP address, network, domain, URL, server for data turnover and discounts them for hosting customers.

The visitors, clients or customers are shown on the right with their end apparatuses, where the apparatuses are connected either through wires or by wireless method connected to an Internet access server with integrated or connected AAA—Authentication, Authorization and Accounting server, which counts the Internet access fees, takes the Internet access accounts of the visitors and charges them with discounts from them the fees.

The Second Line of the Diagram

The HINDUS (Host, IP-Address, Network, Domain, URL, Server Based Accounting System) is shown as the new Internet Access Accounting process according to the invention, wherein an arbitrary HINDUS financed by the bidder, an Internet access account limited on one or more HINDUS financed by the bidder opens, the current download or turnover of visitors is registered and accounted accordingly.

In addition to the prevailing one-sided turnover of upload and download, there is, of course, a data turnover in the opposite direction, both to the upload server and to the download one, that is in the nature of TCP/IP, which controls the questions, whether the data sent have arrived, they can be used or they are useful, but that does not influence the known respectively specified concepts of prevailing upload or download. As it is described under the Diagram 1, the Internet access costs, which depend on the domain, are transferred or switched from the account of a visitor or to a HINDUS BAS Internet access account or a user-based Internet access account.

It is also possible, of course, that in some cases, when the Hosting ISP and the access ISP are the same, that the fees for Internet access and those for Internet Hosting are only once registered and accounted instead to let the irrational double accounting, the fees for HINDUS of Internet access and for Internet hosting are only once in one process accounted. In the case only, where the Hosting ISP and the access ISP are two different ones, the Internet access of an Internet Access Provider must be transferred and the access costs must be transferred to an Internet access financed by an Internet Access Provider and the access costs are booked to a HINDUS based access account or its account is charged with the costs.

The process HyperLogLink provides easy change of a primarily public or open user based or related communication beginning with Internet access to a HINDUS BAS (Host, IP-Addresses, Network, Domain, URL, Server Based Accounting Services) with a Hyperlink inserted or placed in any website, which starts an applet, a login script or simply a small program, which makes the user or visitor to log out from his or her user based or user related internet access account and log in or books in to a new HINDUS BAS account. It may be advantageous but currently not performed, to inform the user or visitor, who has taken the costs upon itself.

It may be an extraordinary great advantage for the owner of domain that when it has taken the Internet access costs on itself instead of its visitors or customers, it can have the right to require a protocol, from which it can learn who surfed to its website, when, from where and through which node of choice he or she arrived. Once this information is obtained, the customers can be served better depending on their interests, they may be asked why they have chosen or not chosen one or another ware or service. This is the first network, completely based on permission, and as it is paid by the traders or bidders of goods and services, so the owner of the network is completely free in actions with its network.

The Third Line of the Diagram shows a direct solution where the visitor logs in with his or her known name of HINDUS BAS access account with or without password in the HINDUS financed by the bidder through an entry with telephone network or selection nodes or through another network under PASPPPoE process to an Online Connect Platform and he or she chooses there either a linked DNS (Domain Name Services), a linked NOC (Network Operation Center) or his or her identification is accomplished or accounted in a way paid by the bidder by HINDUS BAS. As it was already mentioned at the HINDUS BAS, the Internet access is limited to the one or more involved HINDUS sites.

In the Internet access process financed by the bidder can also involved or addressed DHCP and/or Dyn DNS and/or where it is possible the new Ipv6 for function, but they are not decisively relevant for the process according to the invention.

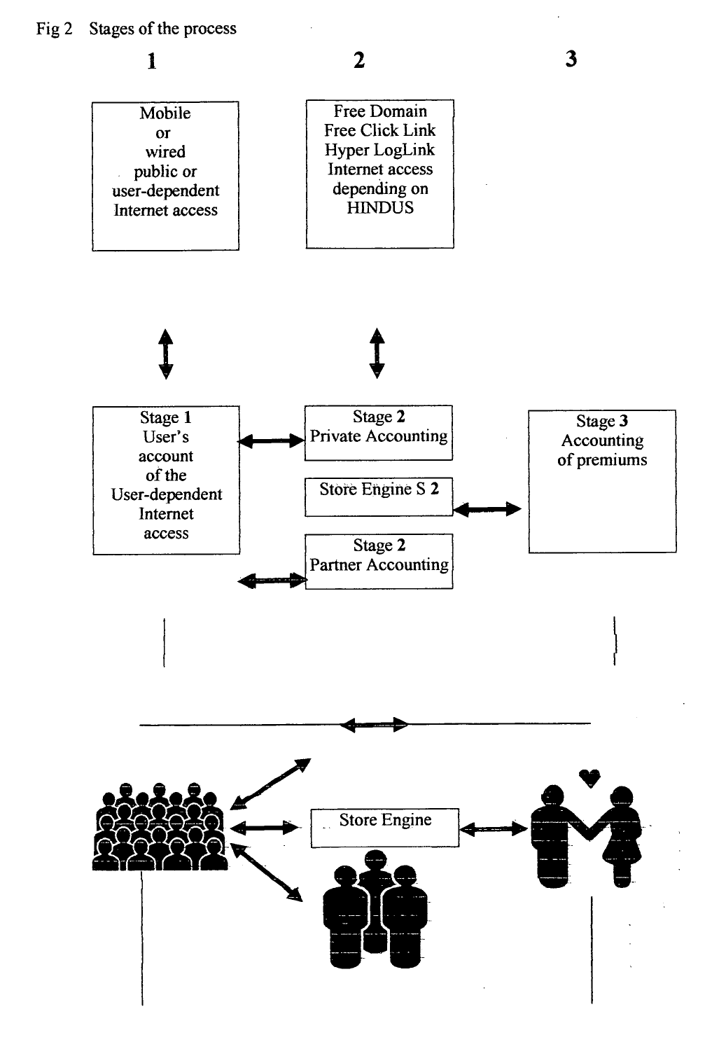

The FIG. 2 is explained here.

One can well see the three stages of the process here. The customer logs in or he or she is, booked here manually or automatically with his or her known user depending account to the provider of telecommunication in our network financed by the bidder.

A logout takes place from the user depending account and a login takes place to the currently searched HINDUS BAS (Host, IP-Address,Netvork, Domain, URL, Access Services based on Server or Page) depending Internet access account in the second stage and the telecommunication provider connects the desired trader, servicing company to the customer directly through VoIP or with connection to its e-trade page and either through the Private Accounting, where the visited domain takes over the costs of the visit to the said. domain or through a Partner Accounting, where the visited bidder takes on itself the costs of mediating partner for mediation in addition to the costs of the visit, if no opposite provision was made.

A usual e-commerce application starts here at the bidder of any goods or services or respectively a transaction takes place between the buyer and the seller and thereafter, as third stage, a premium is accounted or credited to the customer's account or to the customer's premium account. The whole process is shown more clearly with pictograms under the diagram, where the private communication and the accounting are shown with two symbolic figures representing the bidder and the customer.

Under the pictograms is shown the connection with two partners and behind the customer for Partner Accounting and on the right side the trader and customer with premium (heart) are shown. In comparison with the process according to the invention there are currently simple user dependent systems or person related ones using network access identified by customer's telephone number among the ISP providers based on wired or wireless telephone service companies, however the mobile phone companies are moving towards to replace the wired technology to packet-switched one.

The introduction of solutions financed by the bidder, which became proved in the wired networks become progressively unavoidable also in the packet-switched technologies.

There are at least 3 partners who take part in a transaction. The first is the Telco or SISP, the second is the customer or buyer, the third is the trader or bidder, who sells goods or services to the customer and makes the premiums of network available to the customer. A fourth partner can be involved in the POS (Point of Sales) organized in the network providing the telecommunication connections to the SISP or to the traders and servicing companies through its POS WLAN infrastructure.

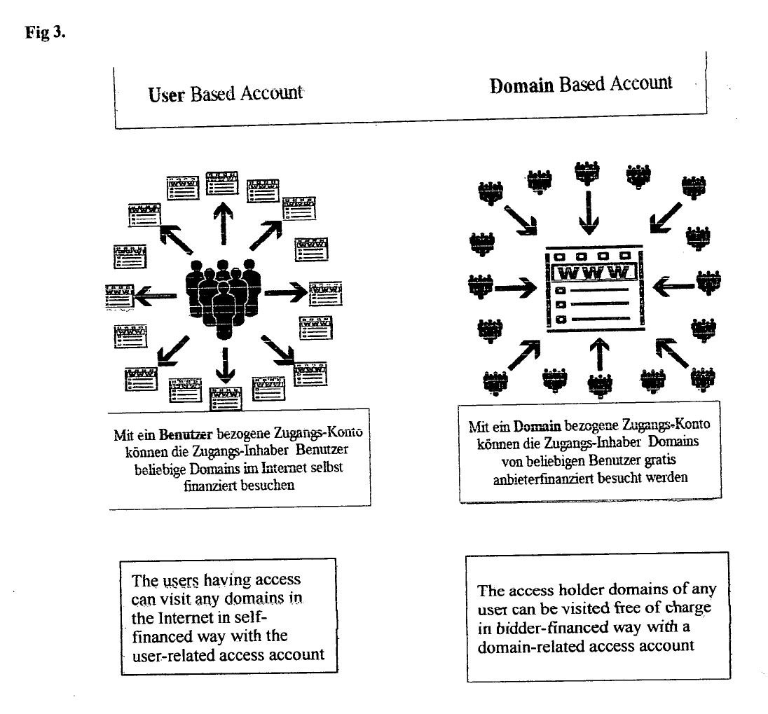

The FIG. 3 shows the differences between the user-dependent Internet access accounts and the domain-dependent Internet access accounts according to the invention, where it should stressed again that the domain-dependent accounts can be accounted in the way dependent of Hosts, IP Addresses, Network, URL or Server, and all of them can be financed by the bidder.

A WLAN Hotspot is a technical apparatus that offers open access through wireless LAN to an ISP and to an Internet bidder. The Wireless LAN abbreviated as WLAN is a local radio network based on Ethernet and DSL or Backbone connected in another way. The Hotspot consists of a WLAN Access Point comprising a WLAN-Router and several modems and establishing wide band connection to an ISP (Internet Service Provider) with a router unit through XDSL ADSL or SDSL. The connection continues to the Internet through ISP. An accounting unit is attached to the technical units providing Internet access to count the payable accesses. This unit serving for authentication, authorization and accounting (AAA) is the base that the Hotspot keeper could receive payment from the users for its service. A local and independent Hotspot keeper offers the Internet accesses either free of charge to the customers or accounts with them through its specially allocated access account with user name and password. This so-called island solution has a disadvantage for the users that it must repeatedly ask the login data at each entry from the users and they must pay for them each time.

Wireless Internet Service Providers covering several regions take on themselves the establishment and operation of Hotspots before the spot. They include the Hotspots in their own networks. A unit for AAA (Authentication, Authorization and Accounting) is there. The user receives an advantage from it. He or she can access Internet from each Hotspot using his or her login data. The only condition is that the Hotspot belongs to his or her WISP. Having authenticated him- or herself, the user is enabled to access the internet. The accounting is effected not locally but in a central location and the accounts may be made either on the base of time i. e. daily, weekly, monthly or by any other time unit or on the base of quantity. The WISP can offer free of charge Internet access as special service to advertise its products and services there. There may be other Internet access points, which are not free of charge but offer Internet access without any limitation.

The process may be carried out in the simplest way if all the participants that is traders, service companies and also the customers are at first registered with their required accounts and identifiers in the new special bidder financed network for Internet access for shopping and payment and/or motivation, but the said network is also open for foreign participants either free of charge or payable in order to the unregistered customers could be registered and they could participate in the process.

The traders and the servicing companies are registered with their HINDUS (Hosts, Website and/or Internet protocol addresses and/or networks and/or URLs and/or Servers) which the customers can or should visit, characterized in that the owners or operators of HINDUS (Hosts, Website and/or Internet protocol addresses and/or networks URLs and/or Servers) take on themselves in addition to the costs of hosting and/or housing also the Internet access costs from their visitors, who possibly have registered themselves as customers in our bidder-financed packet-switched networks. A possible access of an unregistered visitor can be admitted to some or all sites, but the operator is interested to deal not always with nameless visitors, but that the visitors should be identified by SIM cards, e-mail addresses or by any other method, respectively that the visitors should be accessible under their assigned and registered names and accounts. The whole Authentication, Authorization and Accounting are possible in this way.

The accounts required for the process are proposed according to the invention as follows, where both the limitation and broader admission are also possible according to the application or to the desire of employer. It should be noted here that the mentioned accounts may be or for the simple handling they even should be at the SISP (Special Internet Service Provider) but it is unnecessary that all accounts be present and handled by it, operating those special bidder-financed Internet access portals. It may be also carried out that the seller uses an Internet access account bought from a third party to its own web page, giving the name and password to the SISP with the aim to enable its own visitors to load in, book in, to change the logins and bookings with the assistance of a Hyper LogLink Process. The accounts are basically databanks, records or data fields, which are bidder-financed according to the invention and register and account the Internet access costs among the participants, i. e. the seller, the customer and the SISP.

The accounts of sellers, which may be internally
or externally in a SISP or normal ISP

| | | |
|---|---|---|
| 1 | Bank Link Assets Selling Account | Bank Link-Vermögen- |
| | | Verkaufs-Konto |
| 2 | Sales Account Store Engine | Verkaufs-Applikation Konto |
| | Intern or Extern | |
| 3 | Usual Hosting Account Intern | Internet Publikations Hosting |
| | or Extern | Konto |
| 4 | HINDUS based Internet Access | Internet Zugangs Konto für die |
| | Account | eigenen Seiten |
| 5 | Partner Communications Account | Partner Kommunikations Konto |
| 6 | Value-Mail Message Stamp | Brief oder Nachrichen |
| | Services Account | Wert-Marken Konto |

The accounts of customers, which may be internally
or externally in a SISP or normal ISP

| | | |
|---|---|---|
| 1 | Usual Access Account | Benutzerabhängige Internet |
| | | Zugangs Konto |
| 2 | Bank Link Assets Shopping | Bank-Vermögen Einkaufs- |
| | | Konto |
| 3 | Shopping Action Store | Einkaufs-Konto Waren und |
| | Engine | Dienstleistungen |
| 4 | Premium Communication | Prämium Kommunikation Konto |
| | Account | |
| 5 | Cash Account | Geldbeutel-Konto direkt im |
| | | Endgerät-Chip |
| 6 | Value-Mail Message Stamp | Brief oder Nachrichten Wert-Marken |
| | Services Account | Konto |

The first three accounts of customers and sellers respectively are usual, known and proved accounts only the fourth, fifth and sixth ones are new and added according to the invention.

One can name the following exchange and accounting centers CIXA (Customer Identification eXchange Accounting), WebeXchange, VoIP ID or Customer Dealer Registrations Center working with packet-switched technology and where the bidder can any goods and/or services, as well as its customers register, all the visits are registered and in bidder-financed way accounted. The costs of visits are always taken over always by the clicked domain, IP-Address or URL. At the end the website becomes more and more frequently visited and one is willing to sacrifice some cents in order to have the website visited free of charge in bidder-financed way. The registration of customers has an extraordinary great advantage in our SISP to SISP network process that the customers can call with favorable prices or even free of charge in our network with premium and also customers of other networks may be also called, of course, through VoIP, so the sellers and service companies organized in our network can call the customers from their Call Center with much more favorable VoIP fees. When a customer registers or books in him-or herself either automatically or manually in a SISP network process, he or she becomes enabled immediately to bidirectional communication i. e. he or she becomes accessible also for the operator. Considering that using VoIP technology one can communicate for a cost hundred times lower and not only within the organizing company but also one can contact with the community of customers, so each seller or servicing company pays for their customers once it is so cheap.

In the solution with mobile phone usage arise additionally costs for usage of connection, because foreign contacts are used when e. g. a customer visits the company XY or clicks it from the rooms of the company X using the networks WLAN or WIMAX. These costs for usage of connection may be calculated and settled between the customer and the servicing company on the base of mutuality or under upon agree by a Roaming-Broker Clearing House or simply by the SISP network process provider.

Our SISP network process is almost the same as NOC (Network Operation Center) or NAC (Network Access Control) or AAA (Authentication Authorization Accounting) network accessing processes with server, but it has a great difference that in the SISP network accessing process no Internet access costs or network access ones arise for the visitor, but they are accounted in bidder-financed way to the traders, servicing companies bidders and advertisers in the network and also in the new packet-switched Internet accesses.

After the buyer and the seller have been registered and the buyer logs in manually or automatically with his or her user-dependent Internet access account, the visited domains take on themselves the Internet access costs in bidder-financed way.

Considering that the customers and visitors pay nowadays for the data turnover after foreign advertisements and they must pay for foreign often undesirable advertisements only to go to the start is really absurd. The introduction of the new bidder-financed packet-switched Internet access processes becomes step by step timelier, because the transmitted advertisements become greater and greater, and it is unheard that one could expect that the customer should pay also for those.

An Example for Implementation

The SISP network process is shown as example for implementation and the functions of the SISP network process are explicated on its base.

A customer, who is either organized or not in the SISP network process, visits a web site registered in the SISP network process using his or her Internet access account of any type from a private access point of any type, advantageously with a user-dependent DSL access account.

The customer can click on a Hyper Log Link process log off/log on link here in the network handling the SISP network process from that an applet, a log on script or a program is started, which logs out the customer from his or her user-dependent DSL access account and logs on him or her to the SISP network process partner on its cost. The customer can create here his or her own SISP network process access account with the aim to log on either automatically or manually with an arbitrary telecommunication terminal apparatus to the SISP network process. If the customer is already registered in the SISP network process, the booking in and the log on is performed in the SISP network process advantageously completely automatically.

If a customer logs on in a public Wireless Access Point registered in the SISP network process or uses that point, he or she is connected either manually or advantageously automatically to the SISP network process center where the required AAA Authentication Authorization and bidder-financed accounting take place. It is defined in this case either in the SISP network process center or through the LBS (Location Based Services), who is the customer and he or she logged on in which Access Point or in which shop or place The characteristic to him or her offers and advertisements are sent then to him or her with the OPPSS Offer Page Pushing Services System through any wireless WLAN, WIMAX GPRS, UMTS infrastructure or process depending on the place where he or se is. As these pages are written with XML, HTML or XHTML or with a similar program allowing access with a browser and they are made suitably to be clicked in mobile computers or mobile phones, the participants need only to click on the Hyperlinks to see the offer, to buy, order or pay. The pages, advertisement contents and/or offers delivered to the customers by the OPPSS (Offer Page Pushing Services System) can be combined also with MCSM (Mobile Customer Relationship Management and a profile can be established for each customer according to his or her interests and/or habits.

There are three different ways or access methods to the bidder-financed Internet account centers, which can allow the Internet access to the visitor in bidder-financed way.

1 Free Domain or Open Domain where each domain has an own domain dependent Internet access account created by the adequately developed Internet access cost registering program, those Internet access costs or domain access costs of the visitor are booked in this account, which lead the customer to the domains delivered by Internet and the Internet access is limited to one or some Internet domains desired by the owner.

The Free Domains or Open Domains may be identified by any name and/or extension of a name or simply by TLD-s (Top Level Domain).

The bidder-financed Internet accesses may be identified also in any other way.

2 Free Click Link or Hyper LogLink where programs or program codes in the Hyperlinks switch the costs depending on or related to the visitor to accounts or processes based on or related to HINDUS BAS (Host, IP-Addresses, Network, Domain, URL, Server based Accounting Services).

3 Free Hotspot with Compulsory Routing, which switches to the bidder-financed Internet access accounts or to the centers of SISP network process connections or accounts.

If a customer enters a shop location organized by any bidder in the SISP network process or approaches to its highlighted area, he or she can visit free of charge the Internet pages financed by the bidder either through previously opened router configuration or through an application with login name and password previously opened by the owner or operator or prepared by a Proxy server. If this access is sent by a compulsory route, the visitor can visit only the compulsorily. prepared own pages of the trader or servicing company, where the processes of access or accounting are always dependent on the public user. In this case the seller gives access to its own Internet access account. In contrary, if the customer is not in the locations of his or her LSP (Local Service Provider), the usage of the partner access is accounted according to agreement with the help of PAPUA (Partner Access Point Using Account) among the partners.

If an access to the SISP Network Process Provider is established with one of the three access methods, one can speak about 4 different accounting methods or processes, in which the Internet access accounts are accessed and accounted. These are Public, Private, Partner and Premium modes, from among them the Public Access is well-known and used since long time, the rest three accounting methods are new and all the methods are specified below.

1 The Public Accounting

The Public user-dependent or visitor-dependent access accounts are used either in Pre-paid or Post-paid way at the public Hotspots or they may be chosen at our DSL accesses with their access identifiers at the Online Connect Choice nodes of the Deutsche Telekom or any other DSL bidder. The identifiers are entered either manually or stored in our router or computer and automatically used for public user-dependent accesses.

The old known methods Public or NAC (Network Access Control) are used in our SISP network process that the visitor could arrive to the SISP Network Process Portal. These Public Accounts can be given by any bidder also before SISP as those limited to a defined data turnover and they are given to ISP access bidders with the hope that customers will not recognize that they usually used 500 to 1000 MB of free contingent and the wicked expensive for the users payable accounts generate high incomes to the providers. The ISP provider takes on itself however, independently in this case the costs for the first 500 to 1000 MB without requiring a single cent from the customer; nevertheless it is the old well-known Public User-dependent Internet access account.

2 The Private Accounting

The Private account is used that the identified customer or visitor visiting his or her own Private Website of any trader or servicing company or stays there, calls for information, makes a telephone call through VoIP (Voice over Internet Protocol), surfs or communicates and the communication costs arisen are taken from the visited bidder i. e. from its ISP (Internet Services Provider) and paid instead of the customer. These public networks or choice nodes can be limited to one or more accessible domains, what is absolutely necessary for us, for the bidder-financed process, if one wishes choose us with the help of Special Domains in the network.

The permanent mobile accessibility of the traders and servicing companies organized in a partner network from the customers' pages is, of course very important, but the premium function is the most important one in the P&P MTS (Partner & Premium Mobile Telecommunication System) in order that the customers could be adequately presented, attracted and rewarded in order to return, consume and buy again and again at the extremely customer friendly Partner H.

3 Partner Accounting

The Partner Accounting is basically almost the same as the Private Accounting, where the traders or bidders take over the Internet access costs from their customers in the case when the customers visit their web pages with offers, but with the small difference that the communication between the customers and the bidders is performed through a third partner or through the rooms of the intermediating partner in wireless way or through Internet to the private pages of the clicked traders, servicing companies or bidders.

The Internet access costs are covered, of course, by a second, third, fourth or further visited or clicked partner if even any other partner is clicked or visited.

If one places the Partner-Portal-Link system according to the invention containing some or all the partners to be connected to the disposal of the customers or visitors, the pages of this Portal Link System would be used like a type of center for connection and accounting, while after the clicking to a Hyperlink belonging to a partner, always the Internet access costs belonging to the clicked participant are activated or switched on for collection.

It would be also easy possible, of course, to include search engines to find the searchable bidder-offered searchable pages respectively our bidder-financed portals should be provided with a search engine, which can search, however, only among the available bidder-financed pages.

The costs of the usage of wireless connections can be added in the partner accounting process, as it was mentioned above, which is with help of a SISP to SISP network process or with a commissioned Roaming-Broker Clearings-House accounted or left free of charge one to another on the base of mutuality.

4 Premium Accounting

When the customer purchases a ware or a service, he or she receives automatically telecommunication services and/or other electronic premiums as rewards. When the customers used the offers and bought, ordered or paid for anything by click, they are registered in the Store Engine (Electronic Sales Applications), as well as in their databases, and a premium is credited automatically to the premium account database of the customers.

We would like to explain as example a simple e-commerce sale application with premium for the sake of easier understanding, wherein an included Store Engine connects an e-payment provider or an e-payment application with a sale process or a PFXSE Premium Function eXtended Store Engine according to the invention connects in addition to the Payment Provider or application, which performs the process of payment and execution, also a telecommunication provider or Telco Services as premium to an electronic sale transaction. In our process, after the customer has ordered and paid by a click a ware and/or service that he or she desired, a previously defined turnover and/or occurrence or a process-depending credit is given by the trader, servicing company or process provider to his or her customer's premium account and this premium is immediately ready for usage. The agreed premium services are always paid by the trader or servicing company to the customers, the costs are taken over and additionally various electronic und/or mobile und/or wired telecommunication services and/or various other services, like pictures, logos, bell sounds, songs, Video records, games etc. can be applied, used or redeemed for premium.

5 Value Mail Message Services and the accounting of premiums or of the yielded services may be completely simply accomplished according to the brought and collected amount of data and/or they may be accounted in a little more complex way using individual pricing to the services and premium services. We can account also the electronic Value Mail Message Services and/or the Value Mail Message Forwarding Services, postage stamps or vouchers, letter correspondence or news services and their forwarding services in similar way here at the payment, which are sent or delivered from the partners in the network to their customers. The Value Mail Message Services integrated in the SISP network process has in addition a special advantage that the customers can change the sent postage stamps or redeem the money orders at the SISP and they can it use as cash for the purchases or usage of any service.

The Value Mail Message Server works almost in the same way as a usual e-mail server having only a small difference that all the letters or mailed items are returned to the sender or consignor, which. are not provided with the minimum value prescribed or set at the server of the receiver or if the required value is not enclosed. The money orders, postage stamps or news stamps sent through the VMMS (Value Mail Message Services) are also stored in the data storage units of the mobile or immobile terminal apparatuses and redeemed again and/or used as tools for payment for purchases. The money orders coupons or authorization certificates sent through WBND (Wertmarken Brief oder Nachrichten Dienst—Money order letters or information service) can be limited according to time and set to defined time points or expired in the time according to the configuration.

As the customers should be kept always occupied and in excited position, we can seek them with E-Buy Play, Shopping Games or with hidden offers, special bargains, questioning related to bargains, attract them to the shops and motivate them with auctions in the bidder-financed networks. When the customers have already entered the network then it may be exactly found out through PDM (Precision Dialog Marketing) what they desire and extraordinarily customer-friendly served.

As the process concerns a really professional process of access to a traders' network, the applications like ERP (Enterprise Resource Planning), (CRM (Customer Relationship Management), CSM (Cross-Selling Management) or other ones are, of course, integrated.

Another possible implementation form of the process for bidder-financed packet-switched access to e-commerce networks or to Internet or to telecommunication system of electronic premiums can be also characterized in that the activated and used e-commerce database applications, Internet access accounting applications respectively administration database ones can be combined or executed in a combined automatic way.

A further possible implementation form of the process for bidder-financed packct-switched access to e-commerce networks or to Internet or to telecommunication system of electronic premiums can be also characterized in that several ISP-s (Internet Service Providers) and/or payment services and/or traders and servicing companies, which offer these extraordinarily customer-friendly services to their customers, even the most different service providers in different countries can set among themselves the bidder-financed and bidder-based accounts through the whole process.

1. A process or method for access to a packet-switched trading or payment network, especially to Internet run by a network provider, and/or a service provider offering telecommunication services through wireless and/or wired network, especially a provider of Internet services (Internet Service Provider—ISP) and/or a provider of payment services, which manage the internal or external money, bank cards or credit cards or access accounts of customers, accounts of users, those of visitors, traders and/or providers of any services in order to perform payments for any goods or services, characterized in that the network access costs of visitors through accounts, which are dependent on host and/or IP address, and/or network and/or domain and/or URL and/or server and/or website to the trader and/or service provider are registered into protocol and accounted in a way financed by the bidders, suppliers, providers, contractors or partners thereof.

2. A process according to the claim 1 characterized in that a premium is credited to the visitor, who visits any domain, for purchases and/or orders of any ware and/or service offered by any domain to his or her user's account especially through products, which may be delivered electronically, like multimedia data, especially audio or video files, ring music for mobile phones.

3. A process according to any of the previous claims characterized in that a change of the cost-bearers takes place under influence of a click to a HyperLogLink according to the invention, i. e. a logoff is performed from a first user-dependent and/or domain-dependent access account and a logon and/or a switch over is performed to a second user-dependent and/or domain dependent access account wherein program modules, subprograms (applets, logon scripts) linked by the Hyperlink are started, which execute a logoff from the first account and a logon to the second account or the logs are switched over.

4. A system to implement the process according to any of the previous Claims characterized in that the process is implemented by means of wired or wireless network components, servers and computer programs. (REMARK: For the sake of order this apparatus claim should be shifted to the end of the sequence, i.e. behind the last method claim)

5. A process according to any of the previous claims characterized in that the access identifiers used by RASPPPoE (Remote Access Service Point to Point Protocol over Ethernet) network access process with or without password correspond to the by surfing touched domain names or at least logically linked to them and the linked domains offer limited bidder-financed access, which can be accounted through the Internet access accounts depending on the opened domain.

6. A process according to any of the previous claims characterized in that in addition to the known User account dependent Internet access account processes supplemented and combined with three new additional accounting processes or more precisely with Private website dependent access accounts of traders or servicing companies, which are always dependent on the clicked, visited or concerned host, and/or IP address, and/or network and/or domain and/or URL and/or server and/or website, where the costs of visits are registered in protocol and accounted in a bidder-financed way), Partner dependent Internet access account processes wherein the costs for connection to the Points of Sales and their usage are accounted or used on the base of mutuality using Partner Access Point Using Accounting program and Premium dependent Internet access account processes wherein the customers become partners and previously defined premiums according to the e-commerce events and transactions are accounted to them an the credits of the customer premium accounts are also added immediately to the customers' accounts and one or more of the said Internet access account processes are used.

7. A process according to any of the previous claims characterized in that the network access and accounting process according to the invention is combined, connected, supplemented and implemented with any Enterprise Resource Planning Program and/or Customer Relationship Management Program and/or Cross Selling Management Program and/or with any other application concerning the electronic trade or services.

8. A process according to any of the previous claims characterized in that in addition to the bidder-financed contents of entertainment, information and services other bidder-financed advertisement contents inserted in the banner or advertisement banners can be faded in.

9. A process according to any of the previous claims characterized in that the customers' credit accounts for the telecommunication services, as well as the accounts of the partners or their databases are indirectly credited with a defined premium after each event of visit or transaction of electronic purchase of any ware or order of any service, these credits are collected and placed to disposal in the accounts for the aims of any account or payment, and they are at the disposal also in the network.

10. A process for transmission of electronic letters or news characterized in that electronic letters and/or news provided with one or more value marks are sent from a first sending server and received by a second receiving server and the value marks are controlled for adequate franking and stored, they are converted by means of an adequate computer program and a SISP or handling computer participating in the process with limitation to the time or otherwise or without limitation into cash or any other means of payment and the receiving servers are configured by means of adequate computer programs in such a way that only the letters and news are received, which have the types in accordance with the user's profile set in the receiving server or those, which are franked according to a previously set lowest value, and the e-mail letters, news or other mailed items, which are either without franking or the value of franking is too low, are returned to the sending server, with or without remark of the unsuccessful sending because of the unsatisfactory franking.
